(19) United States
(12) Patent Application Publication
(10) Pub. No.: US 2022/0264331 A1
(43) Pub. Date: Aug. 18, 2022

(54) METHOD AND APPARATUS

(71) Applicant: NEC Corporation, MInato-ku, Tokyo (JP)

(72) Inventors: Robert ARNOTT, Tokyo (JP); Alberto SUAREZ, Tokyo (JP); Patricia WELLS, Tokyo (JP)

(73) Assignee: NEC Corporation, MInato-ku, Tokyo (JP)

(21) Appl. No.: 17/629,454

(22) PCT Filed: Aug. 27, 2020
(86) PCT No.: PCT/JP2020/033703

§ 371 Date: Jan. 24, 2022

(30) Foreign Application Priority Data
Sep. 6, 2019 (GB) 1912888.3

(51) Int. Cl. H04W 24/02; G06N 3/08; H04L 41/16

(52) U.S. Cl. CPC H04W 24/02; H04W 84/042; H04L 41/16; G06N 3/084

(57) ABSTRACT

We apply the techniques of deep reinforcement learning (RL) to the problem of coverage and capacity optimisation (CCO) in wireless networks. This is motivated by the idea that the type of combinatorial optimisation problems encountered in wireless networks are somewhat analogous to strategy games, for which deep RL has already proven to be an effective approach. We use a computer simulation of a small wireless network to generate synthetic data to train a deep Q network (DQN), and evaluate the performance of the DQN with further simulations. We compare the performance of the DQN with a conventional model-based approach. The results show that the DQN achieves slightly better performance than the conventional method, without the need for an explicit model of the environment. The performance is shown to be further improved by using the DQN within a search algorithm.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to coverage and capacity optimisation in the so-called ‘5G’ (or ‘Next Generation’) systems.

### BACKGROUND ART

### 1 Introduction

The growing complexity of cellular wireless networks has made their management and optimisation an increasingly challenging task. At the same time, emerging network architectures in which many cells are controlled by a centralised processor increase the scope for applying more sophisticated co-ordination and optimisation techniques. The Long Term Evolution (LTE) 4G standard developed by the Third Generation Partnership Project (3GPP) includes a set of Self-Organising Network (SON) features which aim to automate many network management functions, such as coverage and capacity optimisation, mobility optimisation and load balancing. This trend towards automated management and optimisation is set to continue in future with the deployment of 5G wireless networks.

### CITATION LIST

### Non Patent Literature

NPL 1: D. Silver, T. Hubert, J. Schrittwieser, I. Antonoglou, M. Lai, A. Guez et al. “A general reinforcement learning algorithm that masters chess, shogi, and Go through self-play”, Science 07 Dec. 2018: 1140-1144

NPL 2: D. Silver, J. Schrittwieser, K. Simonyan, I. Antonoglou, A. Huang, A. Guez et al. “Mastering the game of go without human knowledge”, Nature, 550:354, 10 2017.

NPL 3: M. N. ul Islam and A. Mitschele-Thiel, “Reinforcement learning strategies for self-organized coverage and capacity optimization”, 2012 IEEE Wireless Communications and Networking Conference (WCNC), Shanghai, 2012, pp. 2818-2823.

NPL 4: S. Berger, A. Fehske, P. Zanier, I. Viering and G. Fettweis, “Online Antenna Tilt-Based Capacity and Coverage Optimization”, in IEEE Wireless Communications Letters, vol. 3, no. 4, pp. 437-440, August 2014.

NPL 5: T. Cai, G. P. Koudouridis, C. Qvarfordt, J. Johansson, P. Legg, “Coverage and Capacity Optimization in E-UTRAN Based on Central Coordination and Distributed Gibbs Sampling”, 2010 IEEE 71st Vehicular Technology Conference, Taipei, 2010, pp. 1-5.

NPL 6: A. Engels, M. Reyer, X. Xu, R. Mathar, J. Zhang and H. Zhuang, “Autonomous Self-Optimization of Coverage and Capacity in LTE Cellular Networks”, in IEEE Transactions on Vehicular Technology, vol. 62, no. 5, pp. 1989-2004, June 2013.

NPL 7: S. Fan, H. Tian and C. Sengul, “Self-optimization of coverage and capacity based on a fuzzy neural network with cooperative reinforcement learning”, in EURASIP Journal on Wireless Communications and Networking, 2014:57

NPL 8: N. C. Luong, D. T. Hoang, S. Gong, D. Niyato, P. Wang, Y.-C. Liang, and D. In Kim, “Applications of Deep Reinforcement Learning in Communications and Networking: A Survey” arXiv preprint https://arxiv.org/abs/1810.07862

NPL 9: C. Zhang, P. Patras and H. Haddadi, “Deep Learning in Mobile and Wireless Networking: A Survey”, in IEEE Communications Surveys & Tutorials. doi: 10.1109/COMST.2019.2904897

NPL 10: Y. Yang et al., “DECCO: Deep-Learning Enabled Coverage and Capacity Optimization for Massive MIMO Systems”, in IEEE Access, vol. 6, pp. 23361-23371, 2018.

NPL 11: Y. S. Nasir and D. Guo, “Multi-Agent Deep Reinforcement Learning for Dynamic Power Allocation in Wireless Networks”, arXiv preprint https://arxiv.org/pdf/1808.00490.pdf

NPL 12: F. Meng, P. Chen, L. Wu and J. Cheng “Power Allocation in Multi-User Cellular Networks: Deep Reinforcement Learning Approaches”, arXiv preprint https://arxiv.org/pdf/1901.07159.pdf

NPL 13: 3GPP Technical Report (TR) 38.901, Study on channel model for frequencies from 0.5 to 100 GHz (Release 15)

NPL 14: V. Mnih, K. Kavukcuoglu, D. Silver, A. A. Rusu, J. Veness, M. G. Bellemare et al. “Human-level control through deep reinforcement learning”, Nature vol. 5 18, pp. 529-533, 26 Feb. 2015.

NPL 15: H. van Hasselt. “Double Q-learning”, Advances in Neural Information Processing Systems, 23:2613-2621, 2010.

NPL 16: B. T. Lowerre, “The HARPY speech recognition system”, Ph.D dissertation, Carnegie Mellon Univ., April 1976.

NPL 17: Kingma, D., Ba, J.: “Adam: A method for stochastic optimization”, arXiv preprint arXiv:1412.6980 (2014) NPL 18: Bellman, R. and Kalaba, R. (1964). “Selected papers on mathematical trends in control theory”, Dover.

NPL 19: F. Chollet et al. “Keras”. https://keras.io, 2015.

NPL 20: J. Garcia and F. Fernández “A Comprehensive Survey on Safe Reinforcement Learning”, Journal of Machine Learning Research vol. 16, pp. 1437-1480, 2015

NPL 21: E. Wagstaff, F. B. Fuchs, M. Engelcke, I. Posner and M. Osborne “On the Limitations of Representing Functions on Sets”, arXiv preprint https://arxiv.org/pdf/1901.09006.pdf

### SUMMARY OF INVENTION

### Technical Problem

Many of the control and optimisation problems encountered in wireless networks can be viewed as combinatorial optimisation problems in which various parameters need to be adjusted to maximise some combination of key performance indicators (KPI). The parameters to be adjusted may include cell transmitted power levels, antenna tilt angles, handover thresholds, admission control thresholds, beamforming configuration and scheduler parameters. Often these optimisation problems are NP-hard and prohibitively expensive to solve, and in practice it is common to use relatively simple heuristics to search for good sub-optimal solutions.

One problem with such approaches is how to explore the very large space of possible parameter settings. One common heuristic is to apply a ‘greedy’ method whereby parameters are adjusted gradually in such a way as to maximise the immediate reward. This is analogous to looking only one move ahead in a strategy game, and can often result in the algorithm becoming stuck in relatively poor local optima. Another problem is that existing methods often rely on simplified mathematical models of the environment to evaluate potential solutions. However the complexity of the real environment is such that any analytical model can be so inaccurate that in practice much (or even all) of the gain from optimisation is lost.

Recently, deep neural networks trained using reinforcement learning have been found to achieve strong performance in strategy games such as Go (NPLs 1 and 2). Furthermore, this performance can be achieved without the need to provide training examples, since the neural network effectively generates its own training data by playing games against itself. Strategy games are closely related to combinatorial optimisation problems. In strategy games the objective is to choose moves that maximise the end reward (winning the game), not just the immediate reward (eg. capturing pieces). Given a board state, a neural network can quickly identify a small set of promising moves from the vast space of available moves. This set of promising moves can then be explored by a search algorithm. This motivates us to ask if a deep neural network could be trained to acquire a similar ‘intuition’ for the types of optimisation problems encountered in wireless networks, and thus out-perform existing heuristics-based search methods. Furthermore, a reinforcement learning agent can operate ‘model-free’ by learning directly from observed data, thus avoiding the need for a mathematical model that can represent the environment accurately.

Ideally, we would like to be able to input (some representation of) the wireless network state to the neural network, and have it output recommendations for parameter adjustments. The present application explores the feasibility of this approach by focusing on the specific problem of Coverage and Capacity Optimisation (CCO). In CCO the objective is to adjust network parameters so as to maximise a metric related to the throughput experienced by the users. Antenna tilt (NPLs 3 and 4) and transmission power are the main parameters that have been considered for CCO. In this work the inventors focus on transmission power optimisation although it will be appreciated that the same approach may be applied to other network management areas as well. NPL 5 introduces a hybrid algorithm with a centralised controller coordinating the execution of distributed Gibbs sampling power allocation processes. Although executed in each of the cells, it relies on calculating and exchanging between cells the impact on long term delay of power changes in neighbouring cells. NPLs 6 and 7 jointly adjust antenna tilts and transmit powers. NPL 6 uses a combination of a heuristic prioritisation of coverage or capacity optimisation with a mixed-integer linear program. NPL 7 combines fuzzy logic with tabular Q-learning and distributed SON entities share their optimisation experience through a centralised controller.

The application of deep learning techniques to wireless communications problems has received significant recent attention, see for example NPLs 8 and 9 and references therein. In NPL 10, deep reinforcement learning is used for coverage and capacity optimisation of massive MIMO system, by controlling two of the parameters used in the user scheduling algorithm. NPLs 11 and 12 use a combination of centralised learning and distributed agents taking actions in each cell or link. NPL 11 applies deep RL to the dynamic power allocation problem in a mobile ad-hoc network, where the power allocation is applied to each link individually and is based on delayed channel state information. NPL 12 compares multiple reinforcement learning methods (deep Q-Learning, policy-based and actor-critic methods) for a cellular network, but the cell association is fixed, independent of any transmission power changes. In contrast, in the present document, transmission power changes can result in changes to the cell association and the amount of resources a given user is allocated in a cell, assumed to be equally shared between all the users connected to that cell.

Our goal in this application is to train a deep neural network to solve the CCO problem in a computer simulation of a small wireless network comprising a number of cells (in this example, 7 cells). We use a model of the wireless network to generate synthetic data for training and testing the neural network.

The rest of this application is organised as follows. Section 2 describes the CCO problem that we will try to solve. Section 3 shows how this problem can be mapped to the standard framework of reinforcement learning. Section 4 describes the baseline methods that we use for comparison to evaluate the performance of our method. Section 5 presents the architecture of the neural network that was used, and Section 6 explains how the neural network was trained. Section 7 describes how the trained neural network can be used within a search-based algorithm. Section 8 shows the performance results from our simulation. Section 9 reflects on the scalability of our approach and other practical issues, and Section 10 presents some concluding remarks. A general system overview is provided in Section 11 with reference to FIGS. 1 to 4.

### Solution to Problem

In one aspect, the present invention provides a method for performing network optimisation, the method comprising: for each of a plurality of user equipments (UEs) in a network environment, estimating and/or measuring at least one respective metric indicative of a current network state for a predefined set of cellular regions of the network environment; determining, for said current network state as represented by said estimated and/or measured metrics for said plurality of UEs, at least one action that maximises an expected future benefit, the at least one action comprising: at least one network optimisation action to be performed in a corresponding cellular region; or a null action in which no network optimisation action is to be performed; and applying said determined at least one network optimisation action in the corresponding cellular region, or applying no network optimisation action, based on a result of said determination; wherein said determining is performed by applying said current network state as represented by said estimated and/or measured metrics for said plurality of UEs, as inputs to a neural network having a feed forward architecture and an output indicative of said determined at least one action.

The estimating and/or measuring at least one respective metric may employ at least one neural network comprising a plurality of sub-networks and a plurality of rectified linear units (ReLUs). In this case, the at least one neural network may be configured to: receive, for each of said plurality of UEs, respective input data representing a current value or values of said at least one respective metric for that UE; accumulate said received input data, to feed the accumulated input data through at least one feed-forward layer with a plurality of nodes, and a plurality of ReLUs; and output information identifying said at least one action that maximises an expected future benefit for a particular network state.

The at least one action that maximises an expected future benefit may be determined based on a difference between said at least one respective metric indicative of a current network state and an estimate of said at least one respective metric if said at least one action were applied.

The expected future benefit may be determined using a discounting factor, and wherein a value of said discounting factor determines whether said expected future benefit is a relatively short-term future benefit or a relatively long-term future benefit. The discounting factor may initially be set to a value (e.g. ‘0’) that maximises an immediate future benefit.

The network optimisation may comprise coverage and capacity optimisation (e.g. transmission power optimisation/antenna tilt optimisation). The at least one metric may be estimated using an environment model for said network environment. The at least one respective metric, for a given UE, may comprise at least one of: a cell association for that UE; a signal-to-interference-plus-noise ratio (SINR) for that UE; and a throughput for that UE.

The at least one network optimisation action may comprise increasing a power offset associated with a cell of said network or decreasing a power offset associated with a cell of said network. The predefined set of cellular regions covered by the network may comprise a predefined set of at least one cell or a predefined set of at least one beam (in at least one cell).

In one aspect, the present invention provides a method for training a neural network having a feed forward architecture for use in network optimisation, the method comprising: performing a plurality of learning iterations, wherein each learning iteration comprises a respective plurality of consecutive time steps, and wherein for each of the plurality of learning iterations said method comprises: i) for each of the respective plurality of consecutive time steps: (a) for each of a plurality of user equipments (UEs) in a network environment, estimating at least one respective pre-action metric indicative of a current network state for a predefined set of cellular regions of the network environment; (b) selecting at least one network optimisation action to be performed in at least one of said cellular regions; (c) for each of the plurality of UEs in the network environment, estimating at least one respective post-action metric indicative of a post-action network state, for the predefined set of cellular regions, after the selected action has been performed; (d) determining an observed reward resulting from applying said selected action based at least on the post-action metric indicative of the network state after the selected action has been performed; and (e) storing, in a memory, a sample comprising the selected action, the observed reward, the at least one respective pre-action metric, and the at least one respective post-action metric in association with one another; ii) extracting a plurality of the stored samples from the memory; and iii) updating the neural network based on said extracted samples, wherein said neural network comprises a plurality of weights and said updating comprises adjusting said weights based on said extracted samples.

The method for training a neural network may further comprise an initial phase in which adjustment of said plurality of weights is performed based on actions selected by a Self-Organising Network (SON) algorithm.

Each network optimisation action in a given state may have a respective associated probability ε defining a probability for selecting that network optimisation action, and wherein said (b) selecting at least one network optimisation action to be performed in at least one of said cellular regions is performed based on said probability ε, and wherein said probability ε gradually changes from an initial value (e.g. ‘1’) to a final value (e.g. ‘0.1’) over said plurality of learning iterations. Each probability ε may have a value between ‘0’ and ‘1’ and said (b) selecting at least one network optimisation action to be performed in at least one of said cellular regions may be performed at random and with a probability of 1-ε for a given network optimisation action.

In one aspect, the present invention provides a method for training a neural network for use in network optimisation, the method comprising: performing a plurality of learning iterations for adjusting a plurality of weights of the neural network, wherein: in an initial phase, adjustment of said plurality of weights is performed based on actions selected by a Self-Organising Network (SON) algorithm; and in a subsequent phase, adjustment of said plurality of weights is performed based on actions selected by said neural network.

The method may further comprise determining whether the neural network has learned to predict the actions of the SON algorithm with a predetermined reliability; and proceeding to said subsequent phase in dependence on said determination.

In one aspect, the present invention provides a method for performing network optimisation, the method comprising: (a) obtaining at least one metric indicative of a current network state for a network environment and treating said current network state as an initial network state; (b) for each initial network state and for each of a plurality of different network optimisation actions that can be applied in said network environment, respectively estimating at least one metric indicative of a subsequent network state for the network environment if that network optimisation action were to be applied when the network environment is in said initial network state; (c) selecting at most a predetermined number ‘B’ of network optimisation actions having the best associated metric for each initial network state; (d) for each selected network optimisation action, determining the subsequent network state; (e) among all subsequent network states, selecting at most a predetermined number ‘W’ of best network states, based on at least one further metric; (f) respectively treating said best estimated network states as initial network states, and repeating step (b) if fewer than a predetermined number ‘D’ of network optimisation actions have been taken to arrive to said subsequent network state from the current network state; (g) identifying, based on said at least one further metric, an optimum network state wherein the optimum network state is a network state for which the at least one metric estimated is determined have a best estimated value; (h) identifying an optimum network optimisation action that when applied in the network environment, in the current network state, will most likely lead to the optimum network state within a fewest possible actions; and (i) applying the optimum network optimisation action in the network environment.

The at least one metric indicative of a current or estimated network state may comprise a throughput metric. The step of respectively estimating at least one metric indicative of a subsequent network state for the network environment may be performed by: for each of a plurality of user equipments (UEs) in the network environment, estimating and/or measuring at least one respective metric indicative of said initial network state for a predefined set of cellular regions of the network environment; determining, for said initial network state as represented by said estimated and/or measured metrics for said plurality of UEs, at least one network optimisation action that maximises an expected future benefit; and applying said determined at least one network optimisation action in the corresponding cellular region based on a result of said determination; wherein said determining is performed by applying said initial network state as represented by said estimated and/or measured metrics for said plurality of UEs, as inputs to a neural network having a feed forward architecture and an output indicative of said determined at least one network optimisation action.

In one aspect, the present invention provides apparatus for performing network optimisation, the apparatus comprising: means for estimating and/or measuring, for each of a plurality of user equipments (UEs) in a network environment, at least one respective metric indicative of a current network state for a predefined set of cellular regions of the network environment; means for determining, for said current network state as represented by said estimated and/or measured metrics for said plurality of UEs, at least one action that maximises an expected future benefit, the at least one action comprising: at least one network optimisation action to be performed in a corresponding cellular region; or a null action in which no network optimisation action is to be performed; and means for applying said determined at least one network optimisation action in the corresponding cellular region, or applying no network optimisation action, based on a result of said determination; wherein said means for determining is configured to apply said current network state as represented by said estimated and/or measured metrics for said plurality of UEs, as inputs to a neural network having a feed forward architecture and an output indicative of said determined at least one action.

In one aspect, the present invention provides apparatus for training a neural network having a feed forward architecture for use in network optimisation, the apparatus comprising: means for performing a plurality of learning iterations, wherein each learning iteration comprises a respective plurality of consecutive time steps, and wherein for each of the plurality of learning iterations said means is configured to: i) for each of the respective plurality of consecutive time steps: (a) for each of a plurality of user equipments (UEs) in a network environment, estimate at least one respective pre-action metric indicative of a current network state for a predefined set of cellular regions of the network environment; (b) select at least one network optimisation action to be performed in at least one of said cellular regions; (c) for each of the plurality of UEs in the network environment, estimate at least one respective post-action metric indicative of a post-action network state, for the predefined set of cellular regions, after the selected action has been performed; (d) determine an observed reward resulting from applying said selected action based at least on the post-action metric indicative of the network state after the selected action has been performed; and (e) store, in a memory, a sample comprising the selected action, the observed reward, the at least one respective pre-action metric, and the at least one respective post-action metric in association with one another; ii) extract a plurality of the stored samples from the memory; and iii) update the neural network based on said extracted samples, wherein said neural network comprises a plurality of weights and said updating comprises adjusting said weights based on said extracted samples.

In one aspect, the present invention provides apparatus for training a neural network for use in network optimisation, the apparatus comprising: means for performing a plurality of learning iterations for adjusting a plurality of weights of the neural network, wherein: in an initial phase, adjustment of said plurality of weights is performed based on actions selected by a Self-Organising Network (SON) algorithm; and in a subsequent phase, adjustment of said plurality of weights is performed based on actions selected by said neural network.

In one aspect, the present invention provides apparatus for performing network optimisation, the apparatus comprising: (a) means for obtaining at least one metric indicative of a current network state for a network environment and treating said current network state as an initial network state; (b) means for respectively estimating, for each initial network state and for each of a plurality of different network optimisation actions that can be applied in said network environment, at least one metric indicative of a subsequent network state for the network environment if that network optimisation action were to be applied when the network environment is in said initial network state; (c) means for selecting at most a predetermined number ‘B’ of network optimisation actions having the best associated metric for each initial network state; (d) means for determining, for each selected network optimisation action, the subsequent network state; (e) means for selecting, among all subsequent network states, at most a predetermined number ‘W’ of best network states, based on at least one further metric; (f) means for respectively treating said best estimated network states as initial network states, and repeating step (b) if fewer than a predetermined number ‘D’ of network optimisation actions have been taken to arrive to said subsequent network state from the current network state; (g) means for identifying, based on said at least one further metric, an optimum network state wherein the optimum network state is a network state for which the at least one metric estimated is determined have a best estimated value; (h) means for identifying an optimum network optimisation action that when applied in the network environment, in the current network state, will most likely lead to the optimum network state within a fewest possible actions; and (i) means for applying the optimum network optimisation action in the network environment.

Aspects of the invention extend to corresponding systems and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### Advantageous Effects of Invention

The above aspect can contribute to solve the above problem.

### BRIEF DESCRIPTION OF DRAWINGS

FIG. 1 is a diagram schematically illustrating an example of a mobile telecommunication system to which the embodiments are applicable.

FIG. 2 is a block diagram illustrating an example of the main components of a UE shown in FIG. 1.

FIG. 3 is a block diagram schematically illustrating an example of the main components of a (R)AN node shown in FIG. 1.

FIG. 4 is a block diagram schematically illustrating an example of the main components of a core network node shown in FIG. 1.

FIG. 5 is a diagram schematically illustrating an example of a small wireless network of C=7 cell sites.

FIG. 6 is a diagram illustrating an example of the interactions between the RL agent and the environment model.

FIG. 7 is a diagram illustrating an example of the feed-forward architecture and the format of the input data.

FIG. 8 is a diagram illustrating an example of an experience replay memory and a separate target neural network \hat{Q}(s, a, \hat{θ}) with weights \hat{θ}.

FIG. 9A is a diagram illustrating an example of the training performance of the RL agent with the modified ε-greedy policy.

FIG. 9B is a diagram illustrating an example of the training performance of the RL agent with the modified ε-greedy policy.

FIG. 9C is a diagram illustrating an example of the training performance of the RL agent with the modified ε-greedy policy.

FIG. 10 is a diagram illustrating an example of a beam search algorithm.

FIG. 11 is a diagram illustrating an example of the distribution of the throughput metricμ for each algorithm relative to the throughput metric for the ‘No CCO’ case.

FIG. 12 is a diagram illustrating an example of the r.m.s. error as a function of the number of UEs.

### DESCRIPTION OF EMBODIMENTS

### 2 System Model

### 2.1 Environment Model

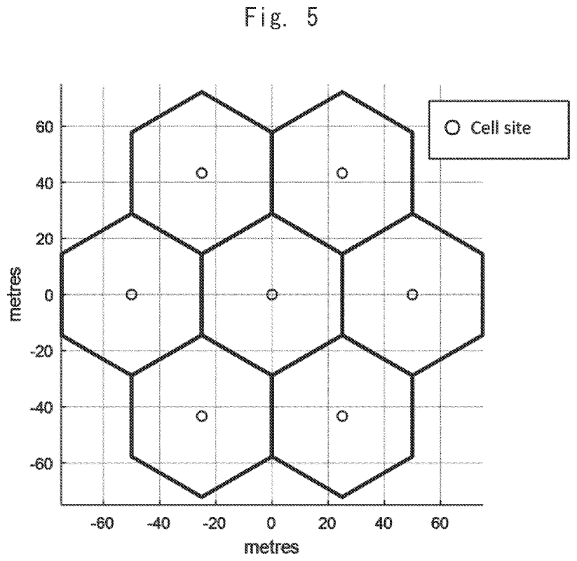

In this section we describe our model of the wireless network in which the RL agent will operate. We assume a small wireless network of C=7 cell sites, as illustrated in FIG. 5, using the parameters shown in Table 1.

TABLE 1

| | |
|---|---|
| Carrier frequency | 3.7 GHz |
| Cell layout | 7 omni-direction cells, inter-site distance 50 m |
| Antenna height | 10 m |
| Fraction of indoor UEs | 100% |
| Pathloss model | ‘Urban Micro Street Canyon’ model from 3GPP |
| | TR38.901 0, with wrap-around and spatial |
| | consistency |
| Transmitted power per | 8 mw per sub-carrier (before CCO adjustment) |
| cell, P | |
| Noise power σ_{N}² per | −126.2 dBm |
| sub-carrier | |
| Δ^{min}, Δ^{max}, Δ^{step} | −6 dB, +6 dB, 3 dB |

In the following exemplary embodiments the 3GPP terminology ‘User Equipment’ (UE) is used to refer to the users. UEs are assumed to arrive and depart from the system at random based on a Poisson process call arrival model. Call durations are sampled from a geometric distribution with a mean of 120 seconds. The location of each UE is selected uniformly at random over the simulation area and each UE is assumed to remain stationary for the duration of its call. The number of simultaneously active UEs is time varying, with a mean of 28, and the number of active UEs is in the range 20 and 40 for around 90% of the time. We denote the number of active UEs at a given time instant as K.

Cell i (where 1≤i≤C) transmits its signal at power level Pᵢ=P10^{Δ}^{ᵢ}^{/10} where P is the default transmit power and Δᵢ is the cell power offset of cell i, measured in dB. We assume that Δᵢ can be adjusted over the range Δ^{min} to Δ^{max} with a step size Δ^{step}.

The Reference Signal Received Power (RSRP) of UE k (where 1≤k≤K) with respect to cell i is given by RSRP_{k,i}=G_{k,i}Pᵢ where G_{k,i} is the total gain of the radio propagation channel between UE k and cell i, comprising antenna gain and propagation pathloss (including shadow fading). Each UE k selects the cell with the highest RSRP_{k,i} as its serving cell cₖ, ie. cₖ=argmaxᵢ RSRP_{k,i}. We denote by Nᵢ the number of UEs served by cell i. The signal-to-interference-plus-noise ratio (SINR) for UE k is given by

$${SINR}_{k} = \frac{R S R {P}_{k , {c}_{k}}}{{σ}_{N}^{2} + {\sum }_{i = 1 , i \neq {c}_{k}}^{C} {I}_{k , i}}$$

The numerator is the power received from the serving cell. The first term in the denominator is the power of the additive white Gaussian noise in the receiver of UE k. The second term is the interference received from cells other than the serving cell of UE k. The interference power I_{k,i} of cell i at UE k is given by

$${I}_{k , i} = \{ \begin{matrix}R S R {P}_{k , i} & if {N}_{i} > 0 \\ 0 & if {N}_{i} = 0\end{matrix}$$

Note that a cell which is not serving any UEs is assumed to transmit no power and therefore causes no interference. We assume that the data rate experienced by UE k is given by Tₖ=log₂(1+SINRₖ/N_{c}_{ₖ} bits/second/Hz in accordance with the Shannon-Hartley theorem. The term N_{c}_{ₖ} in the denominator reflects the assumption that the bandwidth resources of a given cell are shared amongst the UEs served by that cell by a proportional-fair scheduler.

### 2.2 CCO Problem Statement

We can now define the CCO problem precisely. As our objective for optimisation we use the throughput metric

$$μ = \frac{1}{K} {\sum }_{k = 1}^{K} log ( {T}_{k} ) .$$

The reason for the log( ) in this expression is to enforce a degree of fairness between UEs and avoid starvation of UEs with relatively poor radio propagation conditions. The CCO problem can then be stated as a combinatorial optimisation as follows:

$$Given {G}_{k , i} , P , {σ}_{N}^{2} \\ Maximize μ = \frac{1}{K} {\sum }_{k = 1}^{K} log ( {T}_{k} ) \\ Subject to {Δ}_{i} ∈ \{ {Δ}^{min} , {Δ}^{min} + {Δ}^{step} , {Δ}^{min} + 2 {Δ}^{step} , … , {Δ}^{max} \}$$

Note that the cell power offsets Δᵢ can influence the metric μ in two ways. They directly affect SINRₖ, and they can also change the cell association (selection of serving cell cₖ) because they affect RSRP_{k,i}. The fact that adjusting Δᵢ may change the cell association makes μ a discontinuous function of Δᵢ.

### 3 Formulation as a Reinforcement Learning Problem

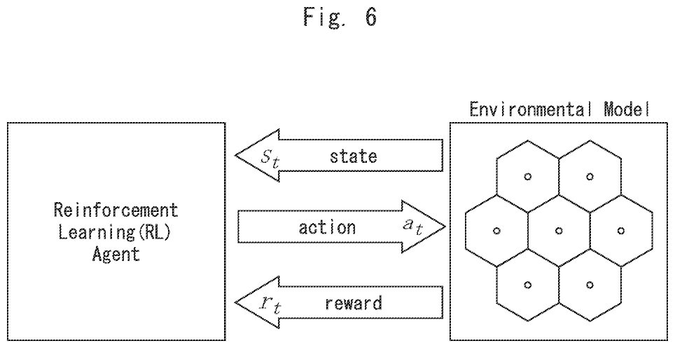

To apply reinforcement learning we first need to formulate the CCO problem as a Markov Decision Process (MDP). This is done by defining the interactions between the RL agent and the environment, as illustrated in FIG. 6. At the highest level, the RL agent interacts with the environment by observing its state, applying actions and observing the subsequent rewards for those actions. There are many possible ways to define the state, actions and rewards for the CCO problem. Our formulation, as described below, is just one possible approach.

In this example, we assume a centralised SON architecture in which one RL agent controls all cells. However, it will be appreciated that more than one RL agent may be used, if appropriate, in which case each RL agent may be configured to control a respective subset of all cells. The RL agent in this example is model-free, meaning that it has no knowledge of the environment model described in section 2.

We assume a time step of 100 ms. At each time step t the RL agent observes the state of the wireless network, sₜ. We assume that the RL agent can observe the following state information: the RSRP measurements RSRP_{k,i}, the serving cell ID cₖ of each UE and the current cell power offset settings Δᵢ. At each time step the RL agent selects one action, where an action consists of either increasing or decreasing the cell power offset in one cell by the amount Δ^{step}. In addition, a null action can be selected which results in no change to the cell power offsets. The total number of actions available to the agent is thus 2C+1=15. Actions are blocked if they would result in Δᵢ exceeding Δ^{max} or Δ^{min}. After applying the selected action, the environment model described in section 2 is invoked to recalculate the cell association cₖ and SINR of each UE, and the new value of the objective function (throughput metric) μ.

Let aₜ denote the action selected by the agent at time step t based on the current observed state sₜ. Let μₜ be the value of the objective function before applying the action and μₜ₊₁ be the value afterwards. Then the reward observed by the agent in response to applying action aₜ is defined as rₜ=μₜ₊₁−μₜ. In other words, the reward is the difference between the throughput metrics observed after and before applying action aₜ. Note that rₜ=0 if the null action is selected. (We could instead define the reward as the observed metric after performing the action, rₜ=μₜ₊₁. In fact this leads to an equivalent MDP, in the sense that the optimal action in each state is the same)

The behavior of the RL agent is expressed as a policy π(s,a) which defines the probability of selecting action a in state s. The optimal policy is the one which maximizes the expected total discounted future return, or long-term reward, defined as E{Rₜ}=Eₙ₌₀^{∞}γⁿ rₜ₊ₙ). (In our case the state transitions and rewards are a deterministic function of the states and actions according to the system model, so the expectation operator can be dropped). The discounting factor γ is a value in the range 0<γ≤1. In our experiment we use γ=0.95.

Note that we intend for the RL agent to operate continuously, adjusting the cell offsets in response to the changing geographical distribution of UEs, and as such our MDP has no terminal state. However, in practice we expect the UE geographical distribution to change relatively slowly compared to the time step of the RL agent. For a static UE geographical distribution, once the agent has adjusted the cell power offsets Δᵢ to the settings that maximize μ any further adjustment of Δᵢ will generate a lower reward than remaining in the current state. Therefore, the state in which all Δᵢ are optimally adjusted is a stable point in which the optimal policy is to select the null action forever (or until the UE distribution changes). The total discounted future return obtained by remaining forever in the same state is Rₜ=Σₙ₌₀^{∞}γⁿrₜ=0. This suggests that even though the RL agent operates continuously, we could nevertheless choose to define a ‘pseudo-terminal’ state with reward rₜ=0 which is entered when the null action is selected. Our experiments suggest that it does not make much difference to the performance of the RL agent whether we treat the null action as a pseudo-terminal state or not. The pseudo-terminal state is not used for the experiments reported in this application.

The optimal policy may be written in the following form

$$π ( s , a ) = \{ \begin{matrix}1 & if a = arg {max}_{{a}^{′}} Q ( s , {a}^{′} ) \\ 0 & otherwise\end{matrix}$$

where Q(s,a) is the expected total discounted future return obtained by selecting action a in state s and following policy π(s, a) thereafter. Thus the problem of finding the optimal policy is equivalent to finding the value Q(s,a) for each state and action, and then selecting the action with maximum Q(s,a) in a given state s. Q(s,a) cannot be stored explicitly for every possible state and action because the state depends on the geographical distribution of the UEs and is therefore continuous. Instead we use a deep neural network as a function approximator to estimate Q(s,a), as described in a subsequent section.

### 4 Performance Baselines

To test the performance of the RL agent we will compare it with three baselines, as follows.

1. No CCO. All power offsets are fixed to Δᵢ=0 dB.

2. Random algorithm. An action is selected uniformly at random at each time step.

3. Greedy algorithm. At each time step, try each available action aₜ (including the null action) tentatively and select the one with maximum reward rₜ.

The greedy algorithm seeks to maximise the immediate reward, whereas the objective of the RL agent is to maximise the long-term reward. In theory the RL agent should therefore be able to out-perform the greedy algorithm.

Note that the greedy algorithm is allowed to try every action tentatively at each time step. We do not allow the RL agent to do this. The RL agent can try only one action at each time step. Equivalently, we could say that the greedy algorithm has access to an ideal model of the environment which it can use to predict the effect of each possible action with perfect accuracy. As noted in section 1, in practice it is not feasible to construct such an accurate mathematical model of the radio environment.

### 5 Neural Network Architecture

The choice of neural network architecture and input data representation can have a large effect on the learning efficiency of the neural network. Several options were considered for this. One option is a simple feed-forward architecture in which the data for all UEs is concatenated into a single input vector which is then fed through multiple fully-connected hidden layers and finally to an output layer which generates the estimated Q-values Q(s,a,θ) for each action a, where θ denotes the parameters of the neural network. The main problem with this approach is that the input layer must be a fixed size but the number of UEs is variable, so we need to assume a maximum number of UEs, and fix the input size based on that. Also, the number of weights between the input layer and the first hidden layer will become very large.

Another option is a convolutional neural network architecture, which is typically used for image processing. We can make an ‘image’ by dividing the environment area into a grid of ‘pixels’ of fixed size (e.g. 3 m×3 m), and setting each pixel value based on the number of UEs in the pixel. This has the advantage that the size of the input layer does not depend on the number of UEs. However it also means that the neural network only sees information about the location of the UEs but not their RSRP measurements. This makes learning more difficult, because in practice location is not always a good predictor of RSRP. For example, one UE within a pixel may have line-of-sight to a given cell whereas another UE in the same pixel may not. In our experiments this approach performed poorly.

A third possibility is a recurrent neural network (RNN). RNNs contain internal feedback and are used for processing sequences (e.g. for time series prediction). In our case the ‘sequence’ consists of UEs and the sequence length is the number of UEs, K. This architecture can cope with the number of UEs being variable. However one feature of RNNs is that the output depends on the ordering of the input sequence, whereas in our exemplary application the function Q(s,a,θ) that we want to approximate does not depend on the ordering of the UEs. In theory the neural network can learn that the ordering is irrelevant, but it makes the learning more difficult and in our experiments this approach also did not perform well.

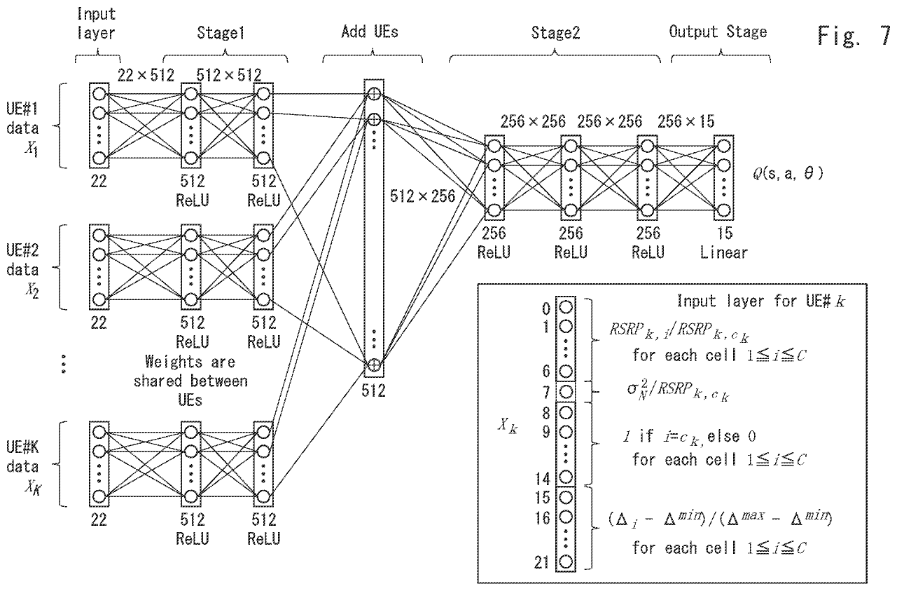

Instead we used the modified feed-forward architecture shown in FIG. 7. This network consists of three stages. In the first stage, data for each UE is input to a sub-network comprising two feed-forward fully-connected layers with 512 hidden nodes each and rectified linear activation units (ReLU). The same weights are shared by all UEs. The outputs are then merged by simple addition to generate a single length-512 vector. In practice, this is done using a single sub-network, feeding in the data for each UE in turn and accumulating the output. Note that because this network consists only of feed-forward connections the result of the accumulation does not depend on the order in which the UEs are input. In the second stage, the accumulated vector from the first stage is fed through two more fully-connected feed-forward layers with 256 hidden nodes each and ReLU activation units. Finally, there is an output stage consisting of a fully-connected layer with linear outputs to produce Q(s,a,θ) for each action.

The total number of parameters θ (weights and biases) is 475407 of which approximately 58% are in stage 1 and approximately 41% are in stage 2.

FIG. 7 also shows the format of the input data. The data for each UE k is input as a vector Xₖ of length 3C+1=22. The first C entries contain the RSRP of each cell at UE k normalised to the RSRP of the serving cell of UE k. Since the serving cell is (by definition) the one with the largest RSRP, this is a value between zero and one. The first C entries therefore represent the strength of each cell relative to the serving cell and thus indicate which cells cause the most interference to UE k. The next entry is the thermal noise power σ_{N}² normalised to the RSRP of the serving cell of UE k. This is an indication of the strength of the serving cell. The next C entries are a one-hot encoded vector indicating which cell is the serving cell for UE k. The remaining C entries are the current cell power offsets Δᵢ normalised to the range zero to one. Note these entries are the same for all UEs. It may appear that these inputs are redundant, because the effect of the offsets is already reflected in the RSRP values. However, the efficacy of performing a particular action may depend on which actions can be performed subsequently, and actions which would take the cell offsets outside of the range Δ^{min} to Δ^{max} are not allowed, so these inputs are potentially useful to indicate how much adjustment of cell offset is available in each cell.

### 6 Training the Neural Network

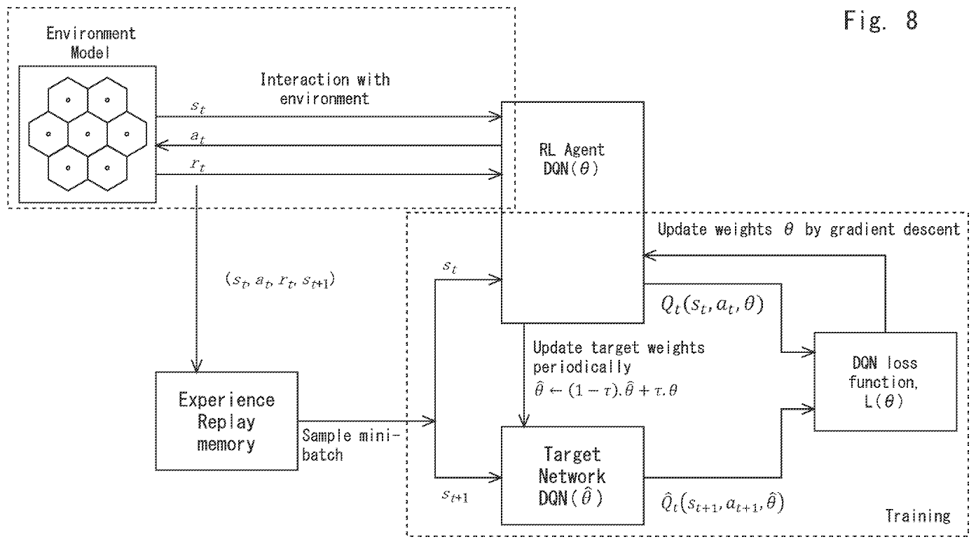

In this section we describe the procedure used to train the neural network. Our method is basically a Deep Q-Network (DQN) trained according to the method described in NPL 14. We employ an experience replay memory and a separate target neural network \hat{Q}(s,a,θ) with weights \hat{θ} as illustrated in FIG. 8.

Training is performed in a series of ‘epochs’. An epoch consists of 390 iterations of 32 time steps each, so one epoch represents a time period of about 21 minutes. In each iteration the following steps are performed.

1. The agent interacts with the environment as described in section 3 for 32 time steps. At each time step the selected action and observed reward are stored in the experience replay memory, along with the neural network input data for the current state and observed next state. The replay memory stores one million such samples and operates in first-in first-out fashion.

2. After 32 time steps have been performed, 128 samples are drawn at random from the replay memory to form a mini-batch, which is then used to update the weights of the neural network.

3. The weights of the target neural network are updated towards the new weights of the training neural network according to \hat{θ}←(1−r)·\hat{θ}+τ·θ, where τ=0.001.

The DQN weights are updated by stochastic gradient descent using the Adam optimizer (NPL 17) with a learning rate of 10⁻⁴, to minimise a mean squared error loss function L(θ) based on the Bellman optimality equation (NPL 18).

The target yₜ for updating the neural network weights is given by

$${y}_{t} = {r}_{t} + γ \hat{Q} ( {s}_{t + 1} , arg {max}_{{a}^{′}} Q ( {s}_{t + 1} , {a}^{′} , θ ) , \hat{θ} )$$

Here \hat{Q}(s,a,\hat{θ}) denotes the output of the target neural network. Note we follow the ‘double-DQN’ method of NPL 15 whereby the action for state sₜ₊₁ is selected by argmax over the output of the training neural network, but the estimated Q-factor for this action is evaluated using the target neural network.

During training, the agent selects actions according to a modified ε-greedy policy, whereby with probability ε an action is selected uniformly at random and with probability 1-ε an action is selected based on Q(sₜ,aₜ,θ). The value of ε is linearly annealed from an initial value of 1 to a final value of 0.1 over the first 1500 training epochs. Rather than always select the action with the maximum Q(sₜ,aₜ,θ), we select action a with probability

$$\frac{exp ( α Q ( {s}_{t} , a , θ ) )}{{Σ}_{{a}^{′} ∈ 𝒜 ( {s}_{t} )} exp ( α Q ( {s}_{t} , {a}^{′} , θ ) )}$$

where [symbol] (sₜ) is the set of actions allowed in state sₜ and α=1000. This is to encourage exploration in the case that there is more than one action with a Q-value close to the maximum.

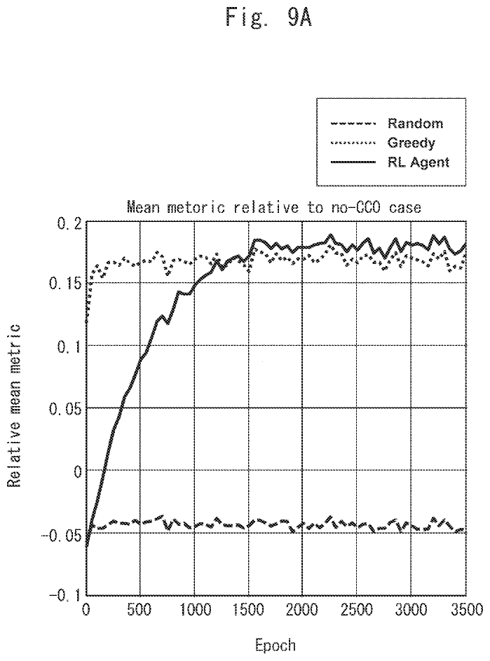

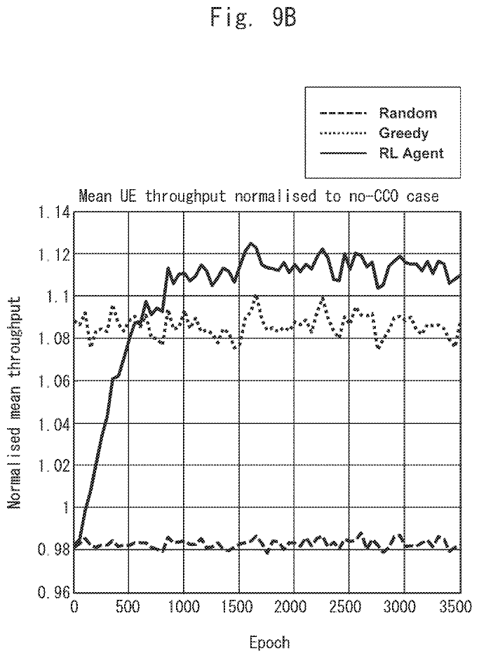

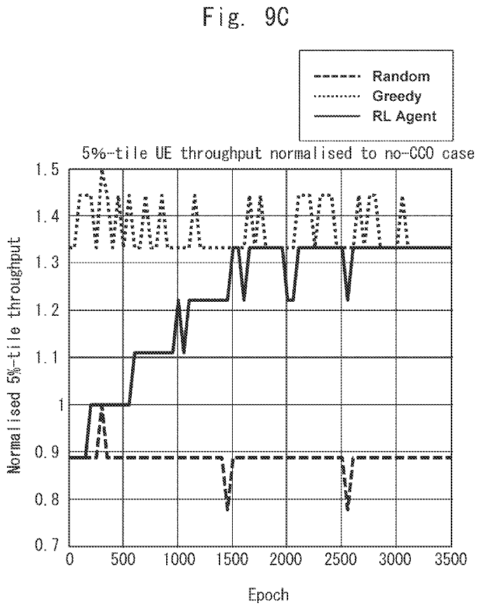

FIGS. 9A, 9B and 9C show the training performance of the RL agent with the modified ε-greedy policy. Initially the agent behaves randomly, because of the high value of ε and random initialization of its weights. The performance improvement reflects both the learning and decreasing values of ε. Eventually, the agent achieves a slightly better performance than the greedy algorithm in terms of both mean metric and mean user throughput, with a small degradation in the 5%-ile throughput, despite selecting actions randomly with probability ε. In general, we observe little or no improvement once the final value of ε=0.1 is reached after 1500 epochs. In part this is due to a relatively low variety of samples in the replay memory as the exploration rate decreases and considering the slow rate of change of the environment.

### 7 Search-Based Method

The DQN algorithm described in section 6 selects and applies a single action based on the state observed at each time step. In this section we describe a search-based method in which at each time step the agent selects an action by planning multiple time steps ahead. We will make use of the DQN as a component in this scheme.

The basic idea of the search-based method is that the agent explores states in the neighbourhood of its current state by imagining taking a series of actions. The search procedure is executed at every time step. The inputs to the search procedure are the current state, sₜ, and the throughput metric that the agent observes from the environment in the current state, μₜ. The output of the search procedure is the state s_{best} which the agent estimates to be the best state which is reachable from its current state within a few time steps (i.e. by performing a few actions). The agent then selects an action to move toward the state s_{best}, and applies that action in the real environment. The new state is then observed and a new search procedure is started. Note that the exploration phase does not involve applying any actions in the real environment. The only action that is applied to the real environment is the one selected at the end of the search process.

The search-based method assumes that the agent can predict the next state when a given action a is taken in a given state s. In the present exemplary application this means that the agent has access to a function s′32 ƒₛ(s,a) which predicts how the RSRP measurements and cell association of each UE observed in state s would change if action a were applied, and returns the new state s′ containing each UE's new RSRP measurements and cell association. This assumption seems to be reasonable in our CCO application, because the observed RSRP measurements should change in a simple and predictable way if the cell power offsets are changed, and the new cell association for each UE can be determined from the predicted RSRP measurements. Note however that we did not need to make this assumption in the case of the DQN.

To identify the best state, the agent needs to estimate the throughput metric for each state explored during the search. For this we use a neural network denoted μ(s)=V(s,θᵥ), where θᵥ are the parameters of the neural network. This network has the same architecture as the DQN network shown in FIG. 7, except that the output stage consists of just a single output corresponding to the estimated throughput metric μ(s) for the input state s. This network was trained independently of the DQN, but using the same environment as described in section 6, with the same experience replay memory parameters. During training the actions were selected by the greedy algorithm. The objective function for training is simply the mean squared error between the neural network output and the metric observed from the environment, Lᵥ(θᵥ)=(μₜ−V(sₜ,θᵥ))². Note that this is supervised learning, because we are just training the network to predict the observed throughput from the observed network state.

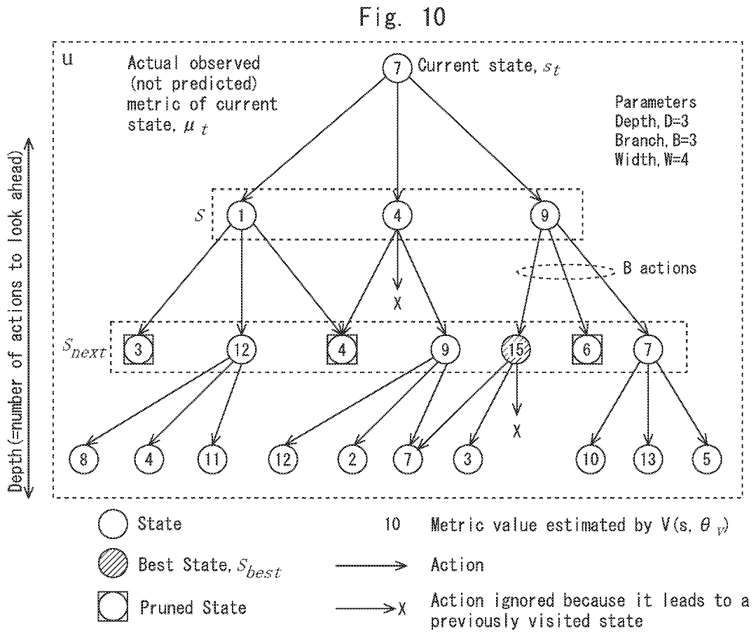

The search procedure is based on a beam search algorithm (NPL 16). The algorithm is given below and an example is shown in FIG. 10. The beam search consists of D iterations, where the parameter D is the depth of the search (i.e. the number of actions to look ahead).

The set [symbol] contains all the states visited during the search. At each iteration of the beam search, the algorithm expands the search tree from the set of states currently stored in the set [symbol] (see lines 5-17 of the Beam Search Algorithm below). Both [symbol] and [symbol] are initialised to contain only the current state sₜ. For each state s in [symbol] , we construct a set [symbol] (s) containing the B most promising actions, where the parameter B is the branch factor of the search (i.e. the number of actions that are explored from each visited state). To select the most promising actions, we choose the B actions that have the largest output from the DQN, Q(s,a,θ) (lines 7-9). Note that the null action is excluded because the null action does not change the state and therefore would not contribute to the exploration.

For each action a in [symbol] (s) we find the new state s′ that would arise by taking action a in state s. This is done by applying the function ƒₛ(s,a) as described above. If the state s′ has not already been visited during the search then it is added to both [symbol] and [symbol] ₙₑₓₜ (lines 12-15), otherwise it is ignored. (Note that since different sequences of actions can lead to the same state, it may often happen that we encounter the same state more than once during the search.)

After considering all states in [symbol] , the set [symbol] ₙₑₓₜ is pruned so that it contains no more than W entries, where the parameter W is the width of the search. This is done by using the neural network V(s,θᵥ) to estimate the throughput metric for each state in [symbol] ₙₑₓₜ, and retaining the W states with the highest estimated metric (lines 18-20). The set [symbol] ₙₑₓₜ is then used as the set [symbol] in the next iteration of the search (line 21).

After completing all D iterations, the states collected in [symbol] are examined and the one with the highest estimated metric V(s, θᵥ) is assigned to s_{best} (line 23). However if the estimated metric of the best state in [symbol] is not greater than μₜ (the observed metric of the current state) then the search returns s_{best}=sₜ (lines 24-26). This corresponds to the case in which the search failed to find any neighbouring state which appears to be better than the current state.

Note that if the depth D is 1 and the branch factor B is 14 (so that all available actions are considered) then the beam search method is equivalent to the greedy algorithm, except that the neural network V(s,θᵥ) is used to evaluate each possible action instead of using an ideal model of the environment. Thus the beam search can be considered as a generalisation of the greedy algorithm, using a non-ideal model of the environment.

Given s_{best}, the agent then needs to select an action to apply in the real environment. For each cell, we compare the cell power offset in state s_{best} with the cell power offset in the current state sₜ. We find the cell with the largest difference, and choose an action which adjusts the cell power offset to reduce the difference. (If there is more than one cell with the same largest difference then we select one of them arbitrarily based on cell number.) In the case that s_{best}=sₜ the null action will be selected.

Beam Search Algorithm

| | |
|---|---|
| 1. | [symbol] ← {sₜ} |
| 2. | [symbol] ← {sₜ} |
| 3. | for i = 1 to D do |
| 4. | [symbol] ₙₑₓₜ ← ∅ |
| 5. | for each s ∈ [symbol] do |
| 6. | [symbol] (s) < ∅ |
| 7. | while \| [symbol] (s)\| < B |
| 8. | $( s ) ← ( s ) ⋃ \{ {arg max}_{a ∉ , a \neq {a}_{NULL}} Q ( s , a , θ ) \}$ |
| 9. | end while |
| 10. | for each a ∈ [symbol] (s) do |
| 11. | s′ = fₛ(s, a) |
| 12. | if s′ ∉ [symbol] |
| 13. | [symbol] ← [symbol] ∪ {s} |
| 14. | [symbol] ₙₑₓₜ ← [symbol] ₙₑₓₜ ∪ {s′} |
| 15. | end if |
| 16. | end for |
| 17. | end for |
| 18. | while \| [symbol] ₙₑₓₜ\| > W |
| 19. | $← \backslash \{ {arg min}_{s ϵ } V ( s , {θ}_{v} ) \}$ |
| 20. | end while |
| 21. | [symbol] ← [symbol] ₙₑₓₜ |
| 22. | end for |
| 23. | ${s}_{best} = {max}_{s \neq {s}_{t}} V ( s , {θ}_{v} )$ |
| 24. | if V(s_{best}, θᵥ) ≤ μₜ |
| 25. | s_{best} = sₜ |
| 26. | end if |

In summary, the high-level idea of this approach is to identify good states by simulating the wireless network in real time using a neural network model. Whilst there are search-based methods for simulating games until the outcome of the game (win/lose) is known, and then using the information from a large number of such simulated games to select actions (moves), such methods are not directly applicable to the area of network optimisation since in this case there is no terminal state to correspond to the end of a game and there is no win/lose condition. Beneficially, in the present application, the useful output from the search is the best state found by the algorithm during the given search procedure (rather than a final state, e.g. win/lose state, or the number of search paths that lead to ‘good’ or ‘bad’ outcomes).

### 8 Performance Evaluation

To evaluate the performance of the RL agent after training, we generated 1000 static random geographical UE distributions, which represent snapshots of the time-varying geographical UE distribution described in section 2.1. These geographical UE distributions were generated independently of the training data, and so (with high probability) were not observed during training. For each of these static scenarios we initialise the cell power offsets Δᵢ randomly, and then apply the random and greedy algorithms described in section 4, and the RL agent. Each algorithm is run for 100 time steps and the throughput metric μ is observed at the end.

For each of the 1000 scenarios we also found the settings of Δᵢ that maximise μ by brute force search, so that we can check how close each algorithm gets to the optimal performance.

Both the DQN and search-based RL agents are tested. For the search-based RL agent we use the method described in section 7 with the parameters D=6, B=8 and W=8. With these parameters around 200 states are visited during the search procedure at each time step.

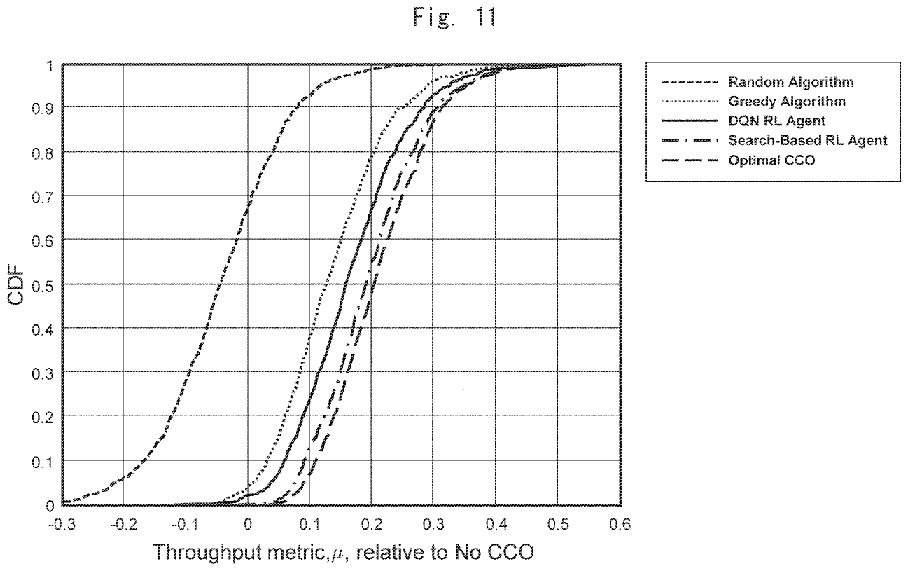

FIG. 11 shows the distribution of the throughput metric μ for each algorithm relative to the throughput metric for the ‘No CCO’ case (i.e. the case with the power offsets of all cells set to zero). We can see that the random algorithm has worse performance than the ‘No CCO’ case. This seems reasonable, as random changes may result in cells being switched off which will result more often than not in a performance degradation. The DQN RL agent shows a significant improvement over the greedy algorithm. When the DQN is used in the search-based method the performance is close to optimal.

Table 2 shows the fraction of the 1000 test cases in which each algorithm is better than no CCO and better than the greedy algorithm. The fraction of test cases in which each algorithm attains optimal performance is also shown. The greedy algorithm finds the optimal solution in only 7.1% of the test cases. The DQN RL agent does slightly better at 9.4%, and the search-based RL agent finds the optimal solution in just over half of the test cases.

TABLE 2

| | Fraction of cases (%) which are | | |
|---|---|---|---|
| | | Better than | |
| | Better than | Greedy | |
| Algorithm | No CCO | Algorithm | Optimal |
| No CCO | 0.0 | 4.4 | 0.0 |
| Random | 32.0 | 2.7 | 0.0 |
| Greedy | 95.6 | 0.0 | 7.1 |
| DQN RL Agent | 97.7 | 62.1 | 9.4 |
| Search-based | 99.8 | 84.5 | 52.0 |
| RL Agent | | | |
| Optimal CCO | 100.0 | 92.9 | 100.0 |

In addition to the throughput metric μ we also compared the mean user throughput

$$\frac{1}{K} {\sum }_{k = 1}^{K} {T}_{k}$$

for each algorithm. Although this is not the quantity we aim to maximise by CCO (because it does not consider fair distribution of resources between UEs) it is still of interest because it relates to the overall spectral efficiency of the wireless network. Table 3 shows the mean user throughput achieved by each algorithm normalised to the ‘No CCO’ case, and averaged over the 1000 test cases. The throughput improvement is modest even with optimal CCO, but it is notable that the RL agent gets much closer to optimal performance than the greedy algorithm.

TABLE 3
Mean UE throughput normalised to
‘No CCO’ case, %

| | |
|---|---|
| No CCO | 100.0 |
| Random | 98.8 |
| Greedy | 104.9 |
| DQN RL Agent | 110.3 |
| Search-based RL Agent | 111.0 |
| Optimal CCO | 112.2 |

### 9 Discussion

In this section we discuss some potential practical issues that may need to be overcome before the type of algorithm described in this application could be deployed in a real wireless network. All of these issues require further work, but here we make some brief observations and outline some possible directions for future investigation.

### 9.1 Generalisation

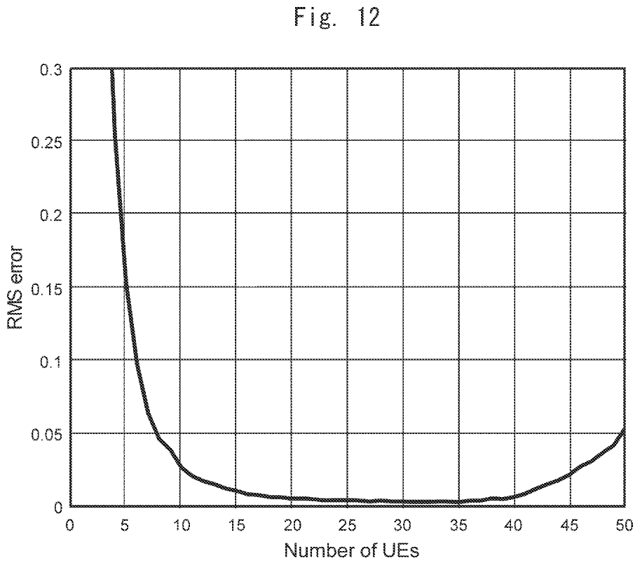

One important caveat that applies to all deep learning methods is that the neural network learns from the data distribution that it observes during training, and its performance may be significantly worse if the input data is not typical of this distribution. To illustrate this, we performed an additional experiment using the trained neural network V(s,θᵥ) described in section 7. This neural network predicts the throughput metric μ(s) from the state s. We can measure the accuracy of this prediction by generating random geographical UE distributions and comparing the actual throughput metric calculated using the model of section 2 with the value predicted by the neural network. FIG. 12 shows the r.m.s. error (averaged over 1000 random geographical UE distributions) as a function of the number of UEs. As noted in section 2.1, the number of UEs present during training is usually between 20 and 40. We can see that for this range the r.m.s. error is low, but it increases sharply outside of this range. The results in FIG. 12 show that the neural network can generalise well to geographical UE distributions that it has not seen during training, but only if the number of UEs is within the range seen during training. It does not generalise well outside of this range. Currently it is not clear how serious a problem this is likely to be in practice.

### 9.2 Scalability

Our experiment was based on a very small wireless network, with the RL agent controlling only a small number of parameters. An obvious question is if it could be scaled up to cope with many more cells and parameters. We did not experiment extensively with the hyperparameters controlling the size of the neural network (the number of layers and size of each layer) to see how much it affects performance, so at this time we cannot say how the size of the neural network would need to scale with the number of cells. Based on the results in NPL 21, a linear scaling of the size of the stage 1 layers with the total number of UEs may be necessary. In addition, one feature of DQNs is that the amount of training data required tends to increase with the number of outputs. This is because each training sample effectively trains only one output (the one associated with the action selected in that training sample), so learning becomes slower as the number of outputs grows. This may put a practical limit on the number of outputs, and hence the number of parameters that the DQN can control.

Indeed, using a single neural network to control the parameters of a large wireless network directly is probably not a feasible approach. Instead, some sort of hierarchical architecture seems more promising. For example, the RL agent could examine the wireless network state and identify a small group of cells which appear to require optimisation, and then invoke a lower-level procedure to operate on those cells. In this case the ‘actions’ performed by the RL agent would be the activation of lower-level optimisation procedures which in turn adjust the wireless network parameters, rather than controlling the wireless network parameters directly. The lower-level procedures could themselves be RL agents using separate neural networks, or they could be conventional SON algorithms. When the lower-level procedure has completed, the top-level RL agent would examine the network state again and select a new action.

### 9.3 On-line training

As described in section 6, in the early stages of training the DQN explores by selecting actions randomly according to an ε-greedy policy. The problem with performing randomly selected actions in a live wireless network should be obvious. To mitigate the disruption this could cause, some means of performing the initial training off-line is required or additional constraints could be incorporated to the learning as in safe reinforcement learning methods, see e.g. NPL 20. One way to do the former might be to initially train the RL agent based on the actions selected by a conventional SON algorithm rather than the actions chosen by the RL agent itself. Once the RL agent has learned to predict the actions of the conventional algorithm with sufficient reliability, it could be put on-line to continue training and hopefully further improve its performance. Alternatively, since Q-learning is an off-policy method, the conventional algorithm combined with an exploration policy could be used to try to directly learn the optimal policy.

It may make sense to conduct the initial off-line training phase with the discount factor parameter γ set to zero. For example, in the CCO scenario investigated in this application, setting γ to zero means that the Q-values learned by the DQN are predictions of the immediate reward attained by applying each action. Choosing the action with maximum Q-value is then equivalent to the greedy algorithm described in section 0. Once the RL agent has learned this behaviour by off-line training, γ could be gradually increased during the on-line training phase to further improve the performance. Dynamic adjustment of γ is not a common approach in reinforcement learning and in many applications it would not make any sense. However, for problems such as the one studied in this application, where γ effectively tunes the RL agent between focusing on short-term or long-term reward, it seems to be a reasonable strategy.

### 9.4 Reliability

It is often observed that a neural network is a ‘black box’ in the sense that knowledge of the weight coefficients does not provide any insight into its behaviour. The practical consequence of this is that we cannot guarantee that the neural network will always behave ‘correctly’ when it encounters inputs that it has not seen before. Again, this raises obvious concerns if the neural network is to be used to control a live wireless network. We can reduce the risk of unstable behaviour by having the RL agent recommend actions to a lower-level controller, which can if necessary override the decisions of the RL agent if it detects signs of instability. Note that in the case of the hierarchical architecture discussed in section 9.1 above, the lower-level optimisation procedures could perform this function.

### Conclusions

The present application has considered the application of deep RL to the problem of CCO, and specifically the problem of adjusting transmitted power to maximise throughput. This was motivated by the intuition that if deep RL is effective at solving strategy games then it should also be applicable to the kind of combinatorial optimisation problems encountered in wireless networks. In our experiment based on an idealised computer simulation of a small wireless network consisting of just a few cells, the DQN RL agent out-performs the heuristics-based (greedy) method and does so without requiring an explicit mathematical model of the environment. When combined with a search algorithm, close to optimal performance is achieved. This result is quite encouraging and suggests that the idea of applying deep RL to the optimisation of wireless networks has some potential. Of course, our simple model is very different in size and complexity from a real wireless network, and it is clear that many problems of scalability and robustness would need to be overcome before this approach could be of practical use.

### 11 System Overview

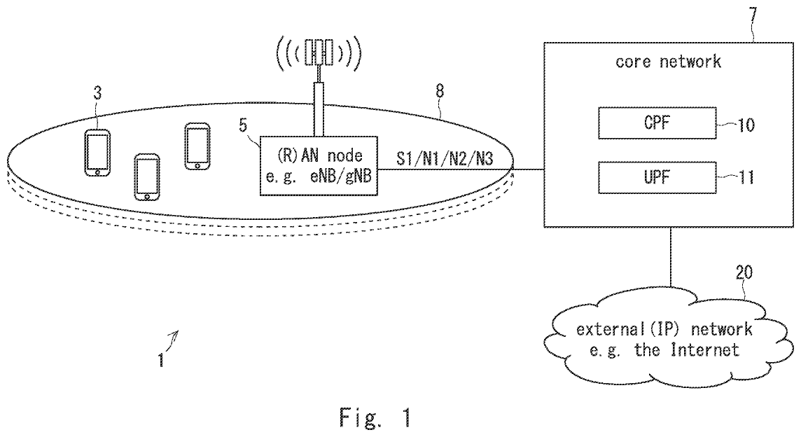

FIG. 1 schematically illustrates a mobile (cellular or wireless) telecommunication system 1 to which the above embodiments are applicable.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst three mobile devices 3 and one base station 5 are shown in FIG. 1 for illustration purposes, the system, when implemented, will typically include other base stations and mobile devices (UEs).

Each base station 5 controls one or more associated cells 8 (either directly or via other nodes such as home base stations, relays, remote radio heads, distributed units, and/or the like). A base station 5 that supports E-UTRA/4G protocols may be referred to as an ‘eNB’ and a base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface and/or the like). Neighboring base stations 5 are connected to each other via an appropriate base station to base station interface (such as the so-called X2′ interface, ‘Xn’ interface and/or the like). The base station 5 is also connected to the core network nodes via an appropriate interface (such as the so-called ‘S1’, ‘N1’, ‘N2’, ‘N3’ interface, and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) and user plane functions (UPFs). From the core network 7, connection to an external IP network 20 (such as the Internet) is also provided.

The components of this system 1 are configured to perform one or more of the above described exemplary embodiments for carrying out optimisation processing, including for example coverage and capacity optimisation for the (R)AN and/or the core network 7.

### User Equipment (UE)

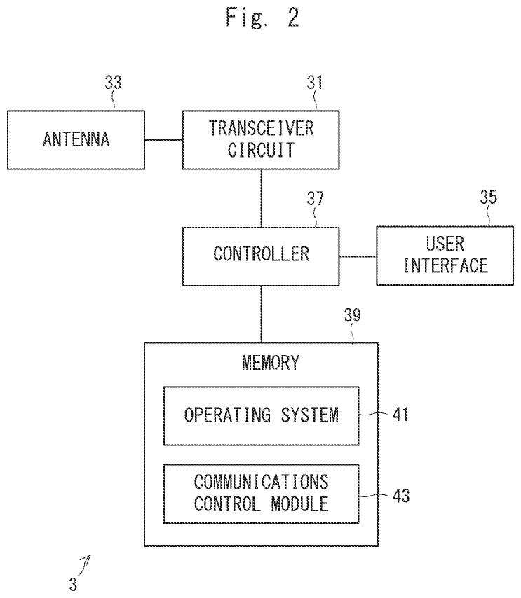

FIG. 2 is a block diagram illustrating the main components of the UE 3 (mobile device) shown in FIG. 1. In the above description, the UE 3 is sometimes referred to as ‘user’. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signalling messages and uplink/downlink data packets between the UE 3 and other nodes, including (R)AN nodes 5 and core network nodes.

### (R)AN Node

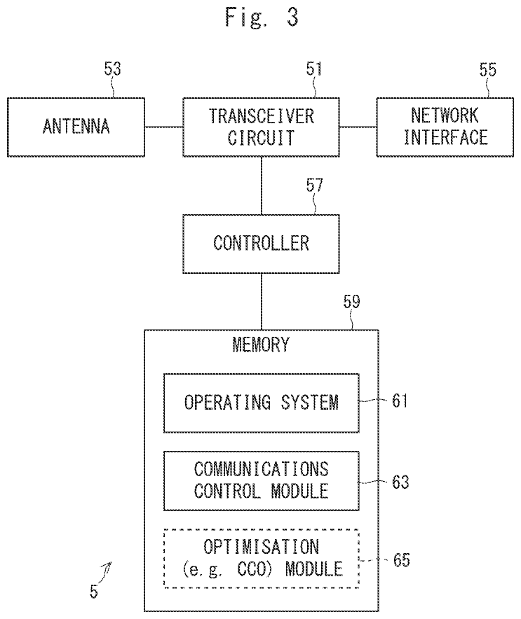

FIG. 3 is a block diagram illustrating the main components of an exemplary (R)AN node 5 (base station) shown in FIG. 1. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N1/N2/N3). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and an optimisation module 65 (optional). The communications control module 63 is responsible for handling (generating/sending/ receiving) signalling between the (R)AN node 5 and other nodes, such as the UEs 3 and core network nodes. If present, the optimisation module 65 performs (at least a part of) the above described optimisation processing using Deep Reinforcement Learning and/or the like. The optimisation processing may include, although it is not limited to, coverage and capacity optimisation for the (R)AN and/or the core network 7.

### Core Network Node

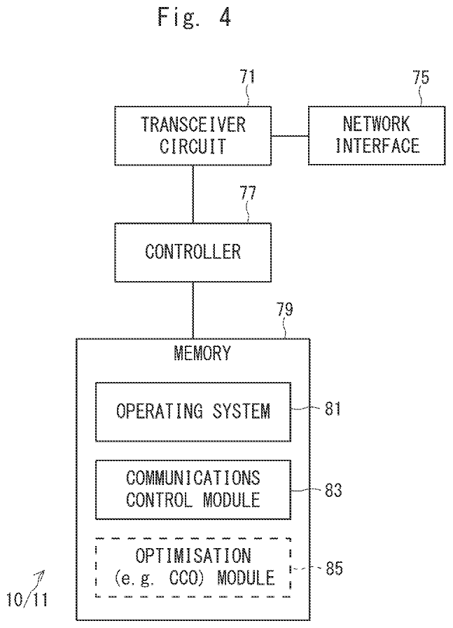

FIG. 4 is a block diagram illustrating the main components of a generic core network node (or function) shown in FIG. 1. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an optimisation module 85 (optional). The communications control module 83 is responsible for handling (generating/sending/receiving) signaling between the core network node and other nodes, such as the UE 3, the (R)AN node 5, and other core network nodes. If present, the optimisation module 85 performs (at least a part of) the above described optimisation processing using Deep Reinforcement Learning and/or the like. The optimisation processing may include, although it is not limited to, coverage and capacity optimisation for the (R)AN and/or the core network 7.

### 12 Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

In the above embodiments, a deep neural network is trained in order to solve a CCO problem in a computer simulation of a wireless (cellular) network comprising a plurality of cells. Whilst in the above example the network comprises 7 cells, it will be appreciated that the embodiments may be applicable in case of any number of cells. For example, the embodiments may be applied to two cells (e.g. a macro cell and a home base station cell; a primary/master cell and a secondary cell; a source and a target cell; and/or the like). In case of beamforming, the embodiments may be applied to a plurality of beams of a single cell. It will also be appreciated that the embodiments may be applied to a plurality of network slices, irrespective of the number of cells/beams used for the slices.

In the above exemplary embodiments the users are items of User Equipment. However, it will be appreciated that in other examples users may be defined differently. For example, the term ‘user’ may refer to any of the following (including any combination thereof): a network slice, an application, a data stream, a type of service, and a type of UE (e.g. Internet of Things device, machine type communication (MTC) device, bandwidth limited device, 3G UE, 4G UE, 5G UE, legacy UE, etc.).

In the above description, the UE, the (R)AN node, and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

It will be appreciated that the functionalities of the optimisation module 65/85 may be carried out by any suitable network node (or function) and these functionalities may distributed among a plurality of network nodes, if appropriate.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above embodiments are also applicable to ‘non-mobile’ or generally stationary user equipment.

Various other modifications will be apparent to those skilled in the art and will not be described in further detail here.

Further, the whole or part of the embodiments disclosed above can be described as, but not limited to, the following supplementary notes.

### Supplementary Note 1

A method for performing network optimisation, the method comprising:

for each of a plurality of user equipments (UEs) in a network environment, estimating and/or measuring at least one respective metric indicative of a current network state for a predefined set of cellular regions of the network environment;

determining, for said current network state as represented by said estimated and/or measured metrics for said plurality of UEs, at least one action that maximises an expected future benefit, the at least one action comprising:
at least one network optimisation action to be performed in a corresponding cellular region; or
a null action in which no network optimisation action is to be performed; and

applying said determined at least one network optimisation action in the corresponding cellular region, or applying no network optimisation action, based on a result of said determination;

wherein said determining is performed by applying said current network state as represented by said estimated and/or measured metrics for said plurality of UEs, as inputs to a neural network having a feed forward architecture and an output indicative of said determined at least one action.

### Supplementary Note 2

The method according to supplementary note 1, wherein said estimating and/or measuring at least one respective metric employs at least one neural network comprising a plurality of sub-networks and a plurality of rectified linear units (ReLUs).

### Supplementary Note 3

The method according to supplementary note 2, wherein the at least one neural network is configured to:

receive, for each of said plurality of UEs, respective input data representing a current value or values of said at least one respective metric for that UE;

accumulate said received input data, to feed the accumulated input data through at least one feed-forward layer with a plurality of nodes, and a plurality of ReLUs; and

output information identifying said at least one action that maximises an expected future benefit for a particular network state.

### Supplementary Note 4

The method according to any of supplementary notes 1 to 3, wherein said at least one action that maximises an expected future benefit is determined based on a difference between said at least one respective metric indicative of a current network state and an estimate of said at least one respective metric if said at least one action were applied.

### Supplementary Note 5

The method according to any of supplementary notes 1 to 4, wherein said expected future benefit is determined using a discounting factor, and wherein a value of said discounting factor determines whether said expected future benefit is a relatively short-term future benefit or a relatively long-term future benefit.

### Supplementary Note 6

The method according to supplementary note 5, wherein said discounting factor is initially set to a value (e.g. ‘0’) that maximises an immediate future benefit.

### Supplementary Note 7

The method according to any of supplementary notes 1 to 6, wherein said network optimisation comprises coverage and capacity optimisation (e.g. transmission power optimisation/antenna tilt optimisation).

### Supplementary Note 8

The method according to any of supplementary notes 1 to 7, wherein said at least one metric is estimated using an environment model for said network environment.

### Supplementary Note 9

The method according to any of supplementary notes 1 to 8, wherein said at least one respective metric, for a given UE, comprises at least one of: a cell association for that UE; a signal-to-interference-plus-noise ratio (SINR) for that UE; and a throughput for that UE.

### Supplementary Note 10

The method according to any of supplementary notes 1 to 9, wherein said at least one network optimisation action comprises increasing a power offset associated with a cell of said network or decreasing a power offset associated with a cell of said network.

### Supplementary Note 11

The method according to any of supplementary notes 1 to 10, wherein said predefined set of cellular regions covered by the network comprises a predefined set of at least one cell or a predefined set of at least one beam (in at least one cell).

### Supplementary Note 12

A method for training a neural network having a feed forward architecture for use in network optimisation according to any of supplementary notes 1 to 11, the method comprising:

performing a plurality of learning iterations, wherein each learning iteration comprises a respective plurality of consecutive time steps, and wherein for each of the plurality of learning iterations said method comprises:
i) for each of the respective plurality of consecutive time steps:
   (a) for each of a plurality of user equipments (UEs) in a network environment, estimating at least one respective pre-action metric indicative of a current network state for a predefined set of cellular regions of the network environment;
   (b) selecting at least one network optimisation action to be performed in at least one of said cellular regions;
   (c) for each of the plurality of UEs in the network environment, estimating at least one respective post-action metric indicative of a post-action network state, for the predefined set of cellular regions, after the selected action has been performed;
   (d) determining an observed reward resulting from applying said selected action based at least on the post-action metric indicative of the network state after the selected action has been performed; and
   (e) storing, in a memory, a sample comprising the selected action, the observed reward, the at least one respective pre-action metric, and the at least one respective post-action metric in association with one another;
ii) extracting a plurality of the stored samples from the memory; and
iii) updating the neural network based on said extracted samples, wherein said neural network comprises a plurality of weights and said updating comprises adjusting said weights based on said extracted samples.

### Supplementary Note 13

The method according to supplementary note 12, further comprising an initial phase in which adjustment of said plurality of weights is performed based on actions selected by a Self-Organising Network (SON) algorithm.

### Supplementary Note 14

The method according to supplementary note 12 or 13, wherein each network optimisation action in a given state has a respective associated probability ε defining a probability for selecting that network optimisation action, and wherein said (b) selecting at least one network optimisation action to be performed in at least one of said cellular regions is performed based on said probability ε, and wherein said probability ε gradually changes from an initial value (e.g. ‘1’) to a final value (e.g. ‘0.1’) over said plurality of learning iterations.

### Supplementary Note 15

The method according to supplementary note 14, wherein each probability ε has a value between ‘0’ and ‘1’ and wherein said (b) selecting at least one network optimisation action to be performed in at least one of said cellular regions is performed at random and with a probability of 1-ε for a given network optimisation action.

### Supplementary Note 16

A method for training a neural network for use in network optimisation, the method comprising:

performing a plurality of learning iterations for adjusting a plurality of weights of the neural network, wherein:
in an initial phase, adjustment of said plurality of weights is performed based on actions selected by a Self-Organising Network (SON) algorithm; and
in a subsequent phase, adjustment of said plurality of weights is performed based on actions selected by said neural network.

### Supplementary Note 17

The method according to supplementary note 16, further comprising determining whether the neural network has learned to predict the actions of the SON algorithm with a predetermined reliability; and proceeding to said subsequent phase in dependence on said determination.

### Supplementary Note 18

A method for performing network optimisation, the method comprising:
(a) obtaining at least one metric indicative of a current network state for a network environment and treating said current network state as an initial network state;
(b) for each initial network state and for each of a plurality of different network optimisation actions that can be applied in said network environment, respectively estimating at least one metric indicative of a subsequent network state for the network environment if that network optimisation action were to be applied when the network environment is in said initial network state;
(c) selecting at most a predetermined number ‘B’ of network optimisation actions having the best associated metric for each initial network state;
(d) for each selected network optimisation action, determining the subsequent network state;
(e) among all subsequent network states, selecting at most a predetermined number ‘W’ of best network states, based on at least one further metric;
(f) respectively treating said best estimated network states as initial network states, and repeating step (b) if fewer than a predetermined number ‘D’ of network optimisation actions have been taken to arrive to said subsequent network state from the current network state;
(g) identifying, based on said at least one further metric, an optimum network state wherein the optimum network state is a network state for which the at least one metric estimated is determined have a best estimated value;
(h) identifying an optimum network optimisation action that when applied in the network environment, in the current network state, will most likely lead to the optimum network state within a fewest possible actions; and
(i) applying the optimum network optimisation action in the network environment.

### Supplementary Note 19

The method according to supplementary note 18, wherein said at least one metric indicative of a current or estimated network state comprises a throughput metric.

### Supplementary Note 20

The method according to supplementary note 18 or 19, wherein said respectively estimating at least one metric indicative of a subsequent network state for the network environment is performed by:

for each of a plurality of user equipments (UEs) in the network environment, estimating and/or measuring at least one respective metric indicative of said initial network state for a predefined set of cellular regions of the network environment;

determining, for said initial network state as represented by said estimated and/or measured metrics for said plurality of UEs, at least one network optimisation action that maximises an expected future benefit; and applying said determined at least one network optimisation action in the corresponding cellular region based on a result of said determination;

wherein said determining is performed by applying said initial network state as represented by said estimated and/or measured metrics for said plurality of UEs, as inputs to a neural network having a feed forward architecture and an output indicative of said determined at least one network optimisation action.

### Supplementary Note 21

Apparatus for performing network optimisation, the apparatus comprising:

means for estimating and/or measuring, for each of a plurality of user equipments (UEs) in a network environment, at least one respective metric indicative of a current network state for a predefined set of cellular regions of the network environment;

means for determining, for said current network state as represented by said estimated and/or measured metrics for said plurality of UEs, at least one action that maximises an expected future benefit, the at least one action comprising:
at least one network optimisation action to be performed in a corresponding cellular region; or
a null action in which no network optimisation action is to be performed; and

means for applying said determined at least one network optimisation action in the corresponding cellular region, or applying no network optimisation action, based on a result of said determination;

wherein said means for determining is configured to apply said current network state as represented by said estimated and/or measured metrics for said plurality of UEs, as inputs to a neural network having a feed forward architecture and an output indicative of said determined at least one action.

### Supplementary Note 22

Apparatus for training a neural network having a feed forward architecture for use in network optimisation, the apparatus comprising:

means for performing a plurality of learning iterations, wherein each learning iteration comprises a respective plurality of consecutive time steps, and wherein for each of the plurality of learning iterations said means is configured to:
i) for each of the respective plurality of consecutive time steps:
   (a) for each of a plurality of user equipments (UEs) in a network environment, estimate at least one respective pre-action metric indicative of a current network state for a predefined set of cellular regions of the network environment;
   (b) select at least one network optimisation action to be performed in at least one of said cellular regions;
   (c) for each of the plurality of UEs in the network environment, estimate at least one respective post-action metric indicative of a post-action network state, for the predefined set of cellular regions, after the selected action has been performed;
   (d) determine an observed reward resulting from applying said selected action based at least on the post-action metric indicative of the network state after the selected action has been performed; and
   (e) store, in a memory, a sample comprising the selected action, the observed reward, the at least one respective pre-action metric, and the at least one respective post-action metric in association with one another;
ii) extract a plurality of the stored samples from the memory; and
iii) update the neural network based on said extracted samples, wherein said neural network comprises a plurality of weights and said updating comprises adjusting said weights based on said extracted samples.

### Supplementary Note 23

Apparatus for training a neural network for use in network optimisation, the apparatus comprising:

means for performing a plurality of learning iterations for adjusting a plurality of weights of the neural network, wherein:
in an initial phase, adjustment of said plurality of weights is performed based on actions selected by a Self-Organising Network (SON) algorithm; and
in a subsequent phase, adjustment of said plurality of weights is performed based on actions selected by said neural network.

### Supplementary Note 24

Apparatus for performing network optimisation, the apparatus comprising:
(a) means for obtaining at least one metric indicative of a current network state for a network environment and treating said current network state as an initial network state;
(b) means for respectively estimating, for each initial network state and for each of a plurality of different network optimisation actions that can be applied in said network environment, at least one metric indicative of a subsequent network state for the network environment if that network optimisation action were to be applied when the network environment is in said initial network state;
(c) means for selecting at most a predetermined number ‘B’ of network optimisation actions having the best associated metric for each initial network state;
(d) means for determining, for each selected network optimisation action, the subsequent network state;
(e) means for selecting, among all subsequent network states, at most a predetermined number ‘W’ of best network states, based on at least one further metric;
(f) means for respectively treating said best estimated network states as initial network states, and repeating step (b) if fewer than a predetermined number ‘D’ of network optimisation actions have been taken to arrive to said subsequent network state from the current network state;
(g) means for identifying, based on said at least one further metric, an optimum network state wherein the optimum network state is a network state for which the at least one metric estimated is determined have a best estimated value;
(h) means for identifying an optimum network optimisation action that when applied in the network environment, in the current network state, will most likely lead to the optimum network state within a fewest possible actions; and
(i) means for applying the optimum network optimisation action in the network environment.

### REFERENCE SIGNS LIST

1 MOBILE (CELLULAR OR WIRELESS) TELECOMMUNICATION SYSTEM
3 MOBILE DEVICES (UE)
5 (R)AN NODE (BASE STATION)
7 CORE NETWORK
8 CELL
20 EXTERNAL IP NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
65 OPTIMISATION MODULE
71 TRANSCEIVER CIRCUIT
75 NETWORK INTERFACE
77 CONTROLLER
79 MEMORY
81 OPERATING SYSTEM
83 COMMUNICATIONS CONTROL MODULE
85 OPTIMISATION MODULE

What is claimed is:

1. A method for performing network optimisation, the method comprising:
for each of a plurality of user equipments (UEs) in a network environment, estimating and/or measuring at least one respective metric indicative of a current network state for a set of cellular regions of the network environment;
determining, for the current network state as represented by the estimated and/or measured metrics for the plurality of UEs, at least one action that maximises an expected future benefit, the at least one action comprising:
at least one network optimisation action to be performed in a corresponding cellular region among the set of the cellular regions; or
a null action in which no network optimisation action is to be performed; and
applying the determined at least one action;
wherein the determining is performed by applying the current network state as represented by the estimated and/or measured metrics for the plurality of UEs, as inputs to a neural network having a feed forward architecture and an output indicative of the determined at least one action.

2. The method according to claim 1, wherein the estimating and/or measuring the at least one respective metric employs at least one neural network comprising a plurality of sub-networks and a plurality of rectified linear units (ReLUs).

3. The method according to claim 2, wherein the at least one neural network is configured to:
receive, for each of the plurality of UEs, respective input data representing a at least one current value of the at least one respective metric for that UE;
accumulate the received respective input data, to feed the accumulated input data through at least one feed-forward layer with a plurality of nodes in the respective sub-network of the plurality of the sub-networks, and the plurality of ReLUs; and
output information identifying the at least one action that maximises an expected future benefit for a particular network state.

4. The method according to claim 1, wherein the at least one action that maximises an expected future benefit is determined based on a difference between the at least one respective metric indicative of a current network state and an estimate of the at least one respective metric if the at least one action were applied.

5. The method according to claim 1, wherein the expected future benefit is determined using a discounting factor, and wherein a value of the discounting factor determines whether the expected future benefit is a relatively short-term future benefit or a relatively long-term future benefit.

6. The method according to claim 5, wherein the discounting factor is initially set to a value that maximises an immediate future benefit.

7. The method according to claim 1, wherein the network optimisation comprises coverage and capacity optimisation.

8. The method according to claim 1, wherein the at least one metric is estimated using an environment model for the network environment.

9. The method according to claim 1, wherein the at least one respective metric, for a given UE, comprises at least one of: a cell association for that UE; a signal-to-interference-plus-noise ratio (SINR) for that UE; and a throughput for that UE.

10. The method according to claim 1, wherein the at least one network optimisation action comprises increasing a power offset associated with a cell of the network or decreasing a power offset associated with a cell of the network.

11. The method according to claim 1, wherein the set of cellular regions covered by the network comprises a set of at least one cell or a set of at least one beam.

12. A method for training a neural network having a feed forward architecture for use in network optimisation, the method comprising:
performing a plurality of learning iterations, wherein each learning iteration comprises a respective plurality of consecutive time steps, and wherein for each of the plurality of learning iterations the method comprises:
i) for each of the respective plurality of consecutive time steps:
(a) for each of a plurality of user equipments (UEs) in a network environment, estimating at least one respective pre-action metric indicative of a current network state for a set of cellular regions of the network environment;
(b) selecting at least one network optimisation action to be performed in at least one of the cellular regions;
(c) for each of the plurality of UEs in the network environment, estimating at least one respective post-action metric indicative of a post-action network state, for the set of cellular regions, after the selected action has been performed;
(d) determining an observed reward resulting from applying the selected action based at least on the post-action metric indicative of the network state after the selected action has been performed; and
(e) storing, in a memory, a sample comprising the selected action, the observed reward, the at least one respective pre-action metric, and the at least one respective post-action metric in association with one another;
ii) extracting a plurality of the stored samples from the memory; and
iii) updating the neural network based on the extracted samples, wherein the neural network comprises a plurality of weights and the updating comprises adjusting the weights based on the extracted samples.

13. (canceled)

14. The method according to claim 12, wherein each network optimisation action in a given state has a respective associated probability ε defining a probability for selecting that network optimisation action, and wherein the (b) selecting at least one network optimisation action to be performed in at least one of the cellular regions is performed based on the probability ε, and wherein the probability ε gradually changes from an initial value to a final value over the plurality of learning iterations.

15. The method according to claim 14, wherein each probability ε has a value between ‘0’ and ‘1’ and wherein the (b) selecting at least one network optimisation action to be performed in at least one of the cellular regions is performed at random and with a probability of 1-ε for a given network optimisation action.

16. A method for training a neural network for use in network optimisation, the method comprising:
performing a plurality of learning iterations for adjusting a plurality of weights of the neural network, wherein:
in an initial phase, adjustment of the plurality of weights is performed based on actions selected by a Self-Organising Network (SON) algorithm; and
in a subsequent phase, adjustment of the plurality of weights is performed based on actions selected by the neural network.

17. (canceled)

18. A method for performing network optimisation, the method comprising:
(a) obtaining at least one metric indicative of a current network state for a network environment and treating the current network state as an initial network state;
(b) for each initial network state and for each of a plurality of different network optimisation actions that can be applied in the network environment, respectively estimating at least one metric indicative of a subsequent network state for the network environment if that network optimisation action were to be applied when the network environment is in the initial network state;
(c) selecting at most a predetermined number ‘B’ of network optimisation actions having the best associated metric for each initial network state;
(d) for each selected network optimisation action, determining the subsequent network state;
(e) among all subsequent network states, selecting at most a predetermined number ‘W’ of best network states, based on at least one further metric;
(f) respectively treating the best estimated network states as initial network states, and repeating step (b) if fewer than a predetermined number ‘D’ of network optimisation actions have been taken to arrive to the subsequent network state from the current network state;
(g) identifying, based on the at least one further metric, an optimum network state wherein the optimum network state is a network state for which the at least one metric estimated is determined have a best estimated value;
(h) identifying an optimum network optimisation action that when applied in the network environment, in the current network state, will most likely lead to the optimum network state within a fewest possible actions; and
(i) applying the optimum network optimisation action in the network environment.

19.-20. (canceled)

21. Apparatus for performing network optimisation, the apparatus comprising:
means for estimating and/or measuring, for each of a plurality of user equipments (UEs) in a network environment, at least one respective metric indicative of a current network state for a set of cellular regions of the network environment;
means for determining, for the current network state as represented by the estimated and/or measured metrics for the plurality of UEs, at least one action that maximises an expected future benefit, the at least one action comprising:
at least one network optimisation action to be performed in a corresponding cellular region among the set of the cellular regions; or
a null action in which no network optimisation action is to be performed; and
means for applying the determined at least one action;
wherein the means for determining is configured to apply the current network state as represented by the estimated and/or measured metrics for the plurality of UEs, as inputs to a neural network having a feed forward architecture and an output indicative of the determined at least one action.

22. Apparatus for training a neural network having a feed forward architecture for use in network optimisation, the apparatus comprising:
means for performing a plurality of learning iterations, wherein each learning iteration comprises a respective plurality of consecutive time steps, and wherein for each of the plurality of learning iterations the means is configured to:
i) for each of the respective plurality of consecutive time steps:
(a) for each of a plurality of user equipments (UEs) in a network environment, estimate at least one respective pre-action metric indicative of a current network state for a set of cellular regions of the network environment;
(b) select at least one network optimisation action to be performed in at least one of the cellular regions;
(c) for each of the plurality of UEs in the network environment, estimate at least one respective post-action metric indicative of a post-action network state, for the set of cellular regions, after the selected action has been performed;
(d) determine an observed reward resulting from applying the selected action based at least on the post-action metric indicative of the network state after the selected action has been performed; and
(e) store, in a memory, a sample comprising the selected action, the observed reward, the at least one respective pre-action metric, and the at least one respective post-action metric in association with one another;
ii) extract a plurality of the stored samples from the memory; and
iii) update the neural network based on the extracted samples, wherein the neural network comprises a plurality of weights and the updating comprises adjusting the weights based on the extracted samples.

23. Apparatus for training a neural network for use in network optimisation, the apparatus comprising:
means for performing a plurality of learning iterations for adjusting a plurality of weights of the neural network, wherein:
in an initial phase, adjustment of the plurality of weights is performed based on actions selected by a Self-Organising Network (SON) algorithm; and
in a subsequent phase, adjustment of the plurality of weights is performed based on actions selected by the neural network.

24. Apparatus for performing network optimisation, the apparatus comprising:
(a) means for obtaining at least one metric indicative of a current network state for a network environment and treating the current network state as an initial network state;
(b) means for respectively estimating, for each initial network state and for each of a plurality of different network optimisation actions that can be applied in the network environment, at least one metric indicative of a subsequent network state for the network environment if that network optimisation action were to be applied when the network environment is in the initial network state;
(c) means for selecting at most a predetermined number ‘B’ of network optimisation actions having the best associated metric for each initial network state;
(d) means for determining, for each selected network optimisation action, the subsequent network state;
(e) means for selecting, among all subsequent network states, at most a predetermined number ‘W’ of best network states, based on at least one further metric;
(f) means for respectively treating the best estimated network states as initial network states, and repeating step (b) if fewer than a predetermined number ‘D’ of network optimisation actions have been taken to arrive to the subsequent network state from the current network state;
(g) means for identifying, based on the at least one further metric, an optimum network state wherein the optimum network state is a network state for which the at least one metric estimated is determined have a best estimated value;
(h) means for identifying an optimum network optimisation action that when applied in the network environment, in the current network state, will most likely lead to the optimum network state within a fewest possible actions; and (i) means for applying the optimum network optimisation action in the network environment.
